(19) United States
(12) Patent Application Publication
(10) Pub. No.: US 2011/0180606 A1
(43) Pub. Date: Jul. 28, 2011

(54) PRE-PRINTED NON-CASH CURRENCY WITH INTEGRATABLE MACHINE-READABLE IDENTIFICATION

(75) Inventor: Andrew J. Schwartz, Chester Springs, PA (US)

(73) Assignee: AUTOMATED CURRENCY INSTRUMENTS, INC., West Chester, PA (US)

(21) Appl. No.: 13/013,516

(22) Filed: Jan. 25, 2011

Related U.S. Application Data
(60) Provisional application No. 61/298,054, filed on Jan. 25, 2010.

(51) Int. Cl. G06K 19/00; B41F 33/00

(52) U.S. Cl. 235/487; 101/483

(57) ABSTRACT

In one embodiment according to the present disclosure, a method is disclosed comprising (a) printing at least one image onto a scrip; (b) printing a face value onto the scrip; (c) providing the scrip to a commercial establishment after step (a) has been performed; (d) printing a unique identifier on the scrip after step (c) has been performed, the unique identifier being machine readable; and (e) activating the scrip in a database associated with the commercial establishment either simultaneously with or after the performance of step (d), resulting in the scrip being assigned a redemption value within the commercial establishment equal to the face value of the scrip.

### BACKGROUND

The present invention relates generally to currency substitutes, also referred to as vouchers, tickets or scrip, that can be used as cash-equivalents in a particular commercial environment, such as in a casino, a retail store, or on a cruise ship, for example, but are not legal tender. For the purposes of this application, the term “scrip” is intended to mean any type of currency substitute that is not legal tender.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings certain embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a schematic drawing illustrating exemplary arrangements of components in a currency-handling device for printing identification means and dispensing a unit of scrip;

FIGS. 2A and 2B show the front side of a first exemplary unit of scrip before and after an identification means has been printed thereon;

FIGS. 3A and 3B show the front side of a second exemplary unit of scrip before and after an identification means has been printed thereon;

FIGS. 4A and 4B show the front and rear sides of a third exemplary unit of scrip after an identification means has been printed on the front side thereof; and

FIGS. 5A and 5B show the front and rear sides of a fourth exemplary unit of scrip after an identification means has been printed thereon;

FIG. 6 is a schematic drawing showing the relationships between components of an exemplary gaming environment that will dispense and/or accept scrip; and

FIGS. 7A and 7B are flow charts illustrating exemplary methods of printing, activating, dispensing, and accepting an instrument of scrip.

### DETAILED DESCRIPTION OF EXEMPLARY EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale.

The following describes particular embodiments of the present invention. It should be understood, however, that the invention is not limited to the embodiments detailed herein. The present invention may be incorporated into existing machines or, alternatively, the system may be incorporated into newly manufactured machines.

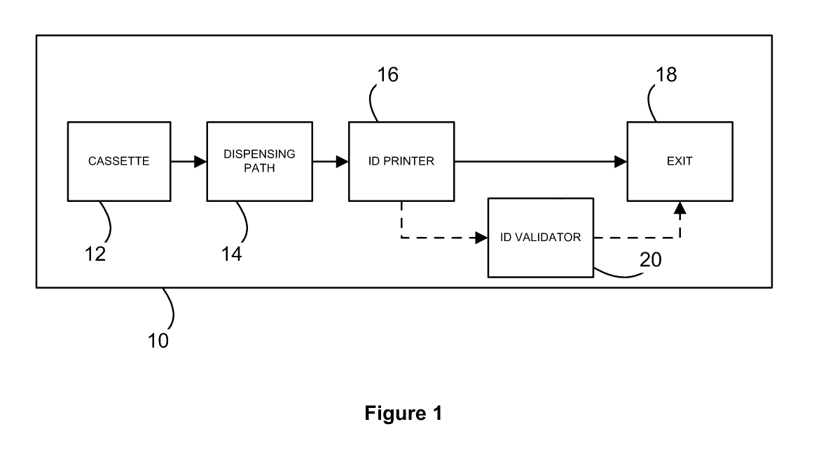

Referring to FIG. 1, an exemplary embodiment of a system 10 will be described. In this embodiment, the system 10 is an automated teller machine (“ATM”), though it should be understood that the system 10 could also be a gaming machine (such as a slot machine or video poker machine), a kiosk, a bill-breaking machine, a cage dispenser, or any other type of currency-handling device within the scope of this invention.

In this embodiment, the currency-handling device 10 is configured to dispense scrip having fixed denominations pre-printed thereon, and may optionally be configured to also dispense cash (i.e. legal tender) or tickets whereon the monetary value of the scrip or ticket is printed just prior to dispensation to the user. PCT International Application No. PCT/US2011/021354, filed Jan. 14, 2011, entitled SYSTEM AND METHOD FOR DISPENSING NON-CASH CURRENCY IN A GAMING ENVIRONMENT, discloses various systems and methods for dispensing non-cash currency items which may be utilized in conjunction with the herein described systems and methods. The disclosure of PCT International Application No. PCT/US2011/021354 is incorporated herein by reference as if fully set forth.

For purposes of this application, the term “scrip” is intended to mean a paper ticket that is not legal tender but, when activated, has a cash value within a particular commercial establishment.

Referring again to FIG. 1, in this embodiment the currency-handling device 10 comprises at least one cassette 12 which holds pre-printed scrip, a dispensing path 14, an identification (hereinafter “ID”) printer 16, and an exit 18. In this embodiment, the unique identifier (which may be, for example, a barcode) is activated when the unique identified is printed onto the scrip. Alternatively, the currency-handling device 10 may comprise an ID validator 20, which validates the barcode or other identification means immediately after it has been printed onto the scrip.

Alternatively, if an ID validator is included in the currency-handling device 10, the unique identifier may be pre-printed on the scrip when it is loaded into the cassette, with the identification means being activated immediately prior to dispensation of the scrip from the currency-handling device 10.

Preferably, the scrip is similar or identical in physical dimensions and characteristics to the legal tender of the location of the gaming environment (for example, in gaming environments in the United States, the scrip would have similar or identical dimensions and characteristics to U.S. Federal Reserve Notes), so that scrip could be dispensed using existing devices that were originally designed to dispense the respective legal tender.

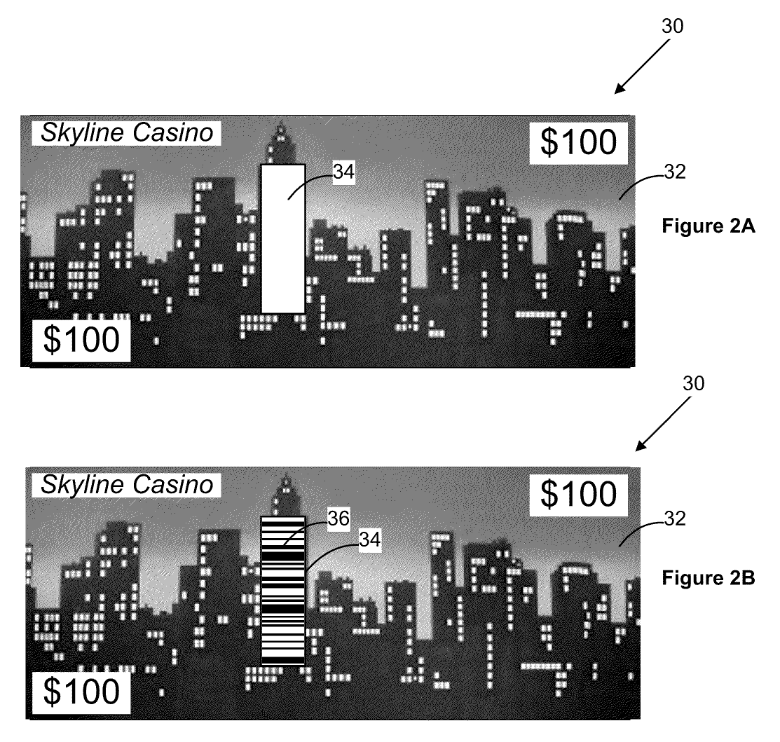

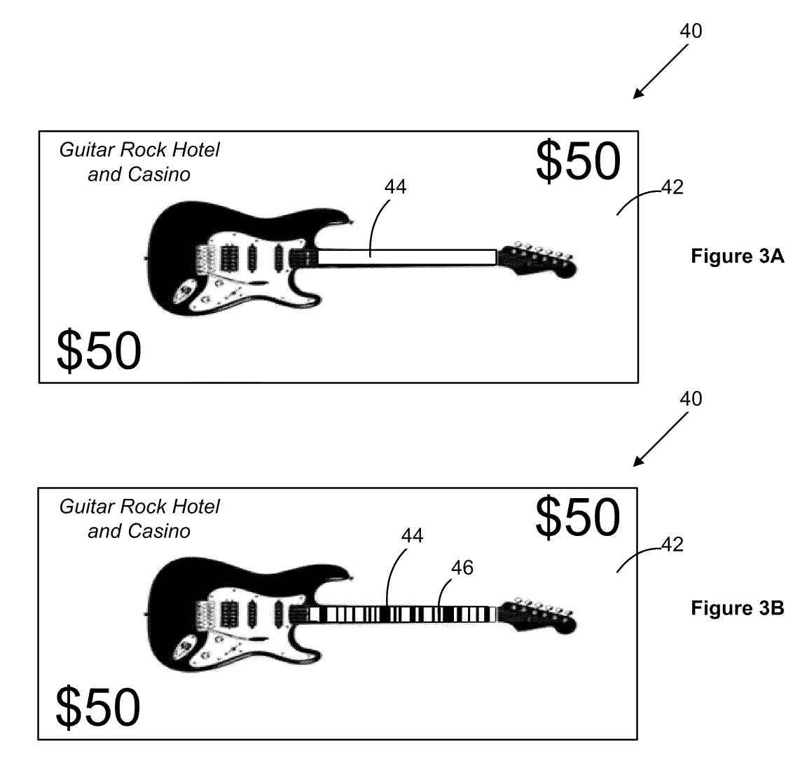

With reference to FIGS. 2A-3B, two exemplary embodiments of scrip are shown. In the example shown in FIG. 2A, the scrip 30 is loaded into the cassette 12 of the currency-handling device 10 with other scrip having the same denomination pre-printed thereon (in this example, $100). The front side 32 of the scrip 30 may also be pre-printed with an illustration, casino information, an advertisement, or any other suitable graphic. When loaded into the cassette 12, the scrip 30 preferably contains a blank area 34, as shown in FIG. 2A. When a user of the currency-handling device 10 selects the total value of scrip to be dispensed from the currency-handling device 10, scrip 30 is moved from the cassette 12 into the dispensing path 14 into a position adjacent the ID printer 16. The ID printer 16 then prints a unique ID 36 in the area 34 and the unique ID 36 is immediately activated in the system used to track scrip value. The activated scrip 30, as depicted in FIG. 2B, is then ejected from the currency-handling device 10 to the user via exit 18. Alternatively, as noted above, the scrip 30 is passed through an ID validator 20 prior to being exited from the currency-handling device. In an additional alternative, as stated above, the ID validator 20 could be used to activate scrip which had the identification means pre-printed thereon at the time the scrip was loaded into the cassette 12.

A second embodiment of scrip 40 is depicted in FIGS. 3A and 3B. Like the scrip 30 described above, the scrip 40 is pre-printed with a particular monetary denomination (in this example, $50) and loaded into the cassette 12 of the currency-handling device 10 with a blank area 44 located on the front side 42 thereof. Before dispensation to the user, a unique ID 46 is printed in the area 44. In the above-described examples of scrip 30, 40, the unique IDs 36, 46 are creatively incorporated into the pre-printed image on the respective front sides 32, 42 of the scrip 30, 40. Preferably, the blank area 44 is bordered on at least one side by a pre-printed image on the scrip 30, 40. More preferably, the pre-printed image forms a perimeter that envelops the blank area 44.

By providing scrip 30, 40 with pre-printed images thereon and printing the IDs 36, 46 at the dispensing point enables the scrip 30, 40 to have a much more attractive appearance than traditional gaming tickets or vouchers, which are typically printed in their entirety at the dispensing point. Optionally, the IDs 36, 46 could be printed onto the scrip 30, 40 after the commercial establishment in which the scrip 30, 40 is used takes possession of the scrip 30, 40 but prior to being loaded into the dispensing point or device. For example, a casino could print IDs onto scrip at the time cassettes are loaded. This alternative procedure may be preferred when scrip is being used in currency-handling device that does not have the capability to rapidly print IDs onto scrip.

In addition, as noted above, it is preferable that that pre-printed images be selected so that the unique identifier is visually-incorporated into a portion of the pre-printed imagery. For example, printing a conventional bar code where the frets of a guitar would normally appear, as illustrated in scrip 40.

An additional advantage associated with the use of scrip as an alternative to cash in a gaming environment is a substantial reduction in the amount of operating capital that the casino is required to maintain in the various ATMs, kiosks, and other currency-handling devices 10 which are located in the casino. In addition, validation of the identification means just prior to dispensation of the scrip from the currency-handling device 10 provides a security measure against currency-handling device 10 tampering and counterfeiting of scrip. For example, if an individual were to break in to an ATM which contained only un-activated scrip, the individual would not be able to obtain any item of redeemable monetary value. Moreover, there is an extremely low likelihood that a counterfeiter could successfully replicate an ID that is currently registered in the casino database as having a monetary value associated with it.

In addition, scrip has several advantages over traditional tickets or vouchers. For example, in a casino environment, patrons are more likely to spend cash (or cash-equivalent currency) if provided as scrip in smaller denominations, instead of as a single voucher. Scrip can also be used in existing ATMs with less modification than would be required for vouchers because the scrip can be stored and dispensed in the same manner as cash instruments (i.e. legal tender), as described above.

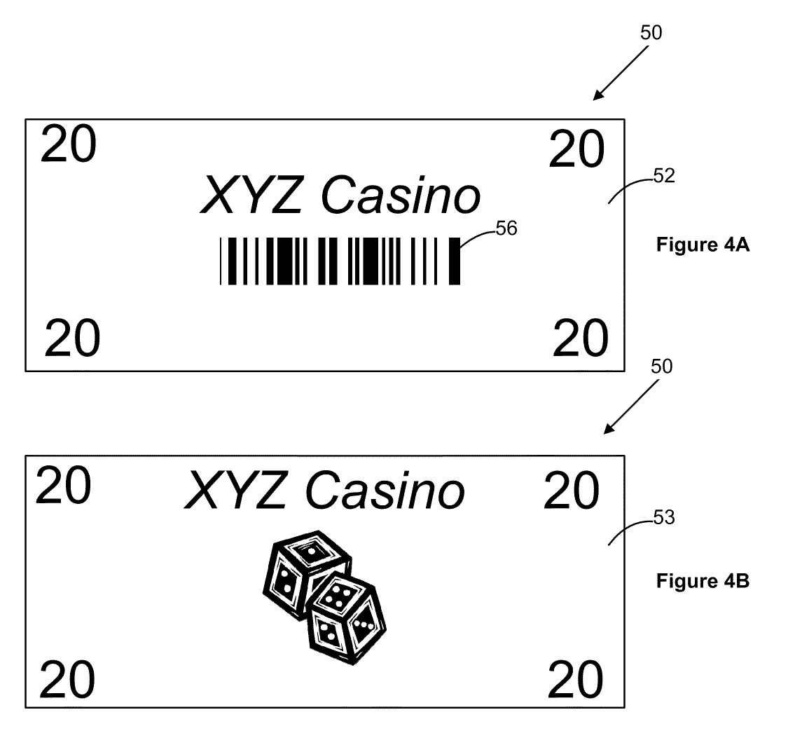

A third embodiment of scrip 50 is shown in FIGS. 4A and 4B. In this embodiment, the ID 56 is printed only on the front side 52 of the scrip 50. In this embodiment, the rear side 53 of the scrip 50 contains a pre-printed graphic image, but not an ID.

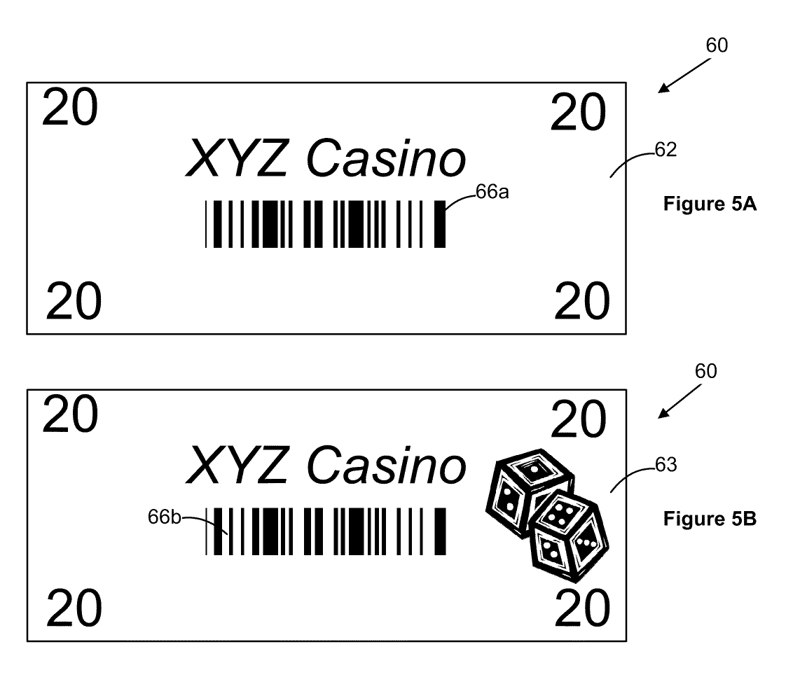

A fourth embodiment of scrip 60 is shown in FIGS. 5A and 5B. In this embodiment, an ID 66a is printed on the front side 62 of the scrip 60 and an ID 66b is printed on the rear side 63 of the scrip 60. In this embodiment, the two IDs 66a, 66b are identical. In situations where the image scanner in a gaming machine, ATM, or other currency-handling device 10 is only capable of reading one side of the scrip 60, the inclusion of IDs 66a, 66b on both the front 62 and rear 63 sides of the scrip 60 eliminates the need for the patron to be exact when inserting the scrip 60 into the currency-handling device 10.

A fifth embodiment of scrip 70 is shown in FIGS. 8A and 8B. In this embodiment, a facing and orientation marking 74 and an ID 76 are printed on the front side 72 of the scrip 70. The purpose of the facing and orientation marking 74 is to enable handling equipment to identify whether the face 72 of the scrip 70 is facing forward and whether the scrip 70 is in a top-edge-up orientation. In this embodiment, the facing and orientation marking 74 is either not provided on the rear side 73 of the scrip 70, a different facing and orientation marking is provided, or the facing and orientation marking 74 is provided in a different location. Alternatively, the ID 76 itself could function as a facing and orientation marking if either no ID or a different ID was provided on the rear side 73. If the ID 76 is to function as a facing and orientation marking, it is preferable that the ID 76 not be centered vertically and horizontally and/or that the ID 76 be asymmetrical so that the orientation of the scrip 70 can be determined from the position of the ID 76 on the scrip 70 and/or orientation of the ID 76.

A sixth embodiment of the scrip 90 is shown in FIGS. 9A and 9B. In this embodiment, the scrip 90 is provided to the commercial establishment in which it is used with pre-printed images, but not a face value 98 or ID 96. This optional method gives the commercial establishment in which scrip 90 is used additional flexibility in the use of scrip 90. For example, the commercial establishment in which the scrip 90 is used could print the face value 98 and the ID 96 onto the scrip 90 just prior to loading the scrip 90 into a cassette to be used in a currency-dispensing device. Alternatively, the commercial establishment in which the scrip 90 is used could print the face value just prior to loading the scrip 90 into a cassette to be used in a currency-dispensing device and print the 98 and the ID 96 onto the scrip 90 when the scrip 90 is being dispensed from the currency-dispensing device.

Providing the scrip 90 to the commercial establishment in which the scrip 90 is used without a face value 98 provides the commercial establishment with more flexibility in the use of the scrip 90 and enables it to maintain a smaller inventory of uncirculated scrip.

Referring again to FIGS. 1, 2A and 2B, it should be understood that, in order to satisfy user requests for different quantities of scrip, the currency-handling device 10 may comprise multiple cassettes, each cassette holding pre-printed scrip of a different denomination. These denominations may be pre-selected based on the issued currency of the market in which the currency-handling device 10 is being used. For example, in gaming environments in the United States, the currency-handling device 10 may comprise separate cassettes holding scrip in denominations of U.S.D. $5, $10, $20, $50, and $100. Alternatively, the currency-handling device 10 may contain a single cassette, and restrict the user to select a scrip withdrawal amount that is a multiple of the denomination of scrip contained in the single cassette, for example multiples of $20.

It should be understood that the ID 36 may be any optical machine-readable representation of data, including, but not limited to, linear/one-dimensional barcodes or two-dimensional matrix codes, symbologies, or geometric figures or patterns. In this embodiment, currency-handling devices throughout the casino, for example gaming machines, kiosks, bill-breaking machines, or cage dispensers, are equipped with optical image readers capable of reading the IDs which are printed on the scrip. For linear/one-dimensional IDs, the optical image reader may be a standard barcode scanner, which uses a single photosensor and performs a manual “scrubbing” of the barcode from one side of the barcode to the other. If a two-dimensional or matrix barcode is used as the ID, a manual barcode reader may not be capable of reading the information contained in the ID. In these cases, a charge-couple device (“CCD”) or a complementary metal-oxide-semiconductor (“CMOS”) sensor may be used to capture an image of the ID. It will be appreciated by one having ordinary skill in the art that many other types of image-capturing devices may be suitable for extracting information from the ID, without deviating from the scope of this invention.

The ID 36 is a unique identifier of the value of the scrip 30. When the ID 36 is validated by the currency-handling device 10, the unique data associated with the ID 36 is preferably registered with an existing system and database that manages gaming vouchers and other currency instruments, for example an existing ticket-in, ticket-out (“TITO”) database.

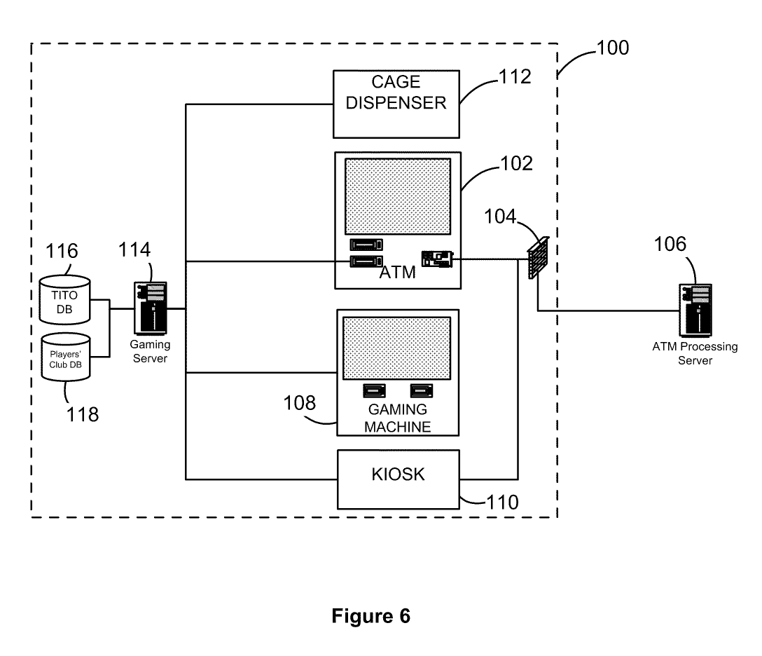

An illustrative TITO database 116 is shown in FIG. 6. The exemplary gaming environment 100 illustrated in FIG. 6 includes an ATM 102, a kiosk 110, a cage dispenser 112, and a gaming machine 108. In this embodiment, the ATM 102 and the kiosk 110 are connected to a remote or offsite ATM processing server 106 through a network firewall 104. The ATM 102, kiosk 110, gaming machine 108, and cage dispenser 112 are all connected to a gaming server 114, which is also connected to the TITO database 116 and a players' club database 118 (which contains, amongst other data, patron account information).

The ID printer 16 and/or ID validator 20 in the currency-handling device (for example one of the ATM 102, gaming machine 108, or kiosk 110) is preferably connected to the gaming server 114, so that the value of the scrip 30 is set to face value (in this example, $100) in the TITO database 116 when the ID 36 is printed on the scrip 30 or is read by the ID validator 20 in the dispensing path 14. A similar configuration could be used in dispensing machines used by casino employees within the casino cage (for example cage dispenser 112).

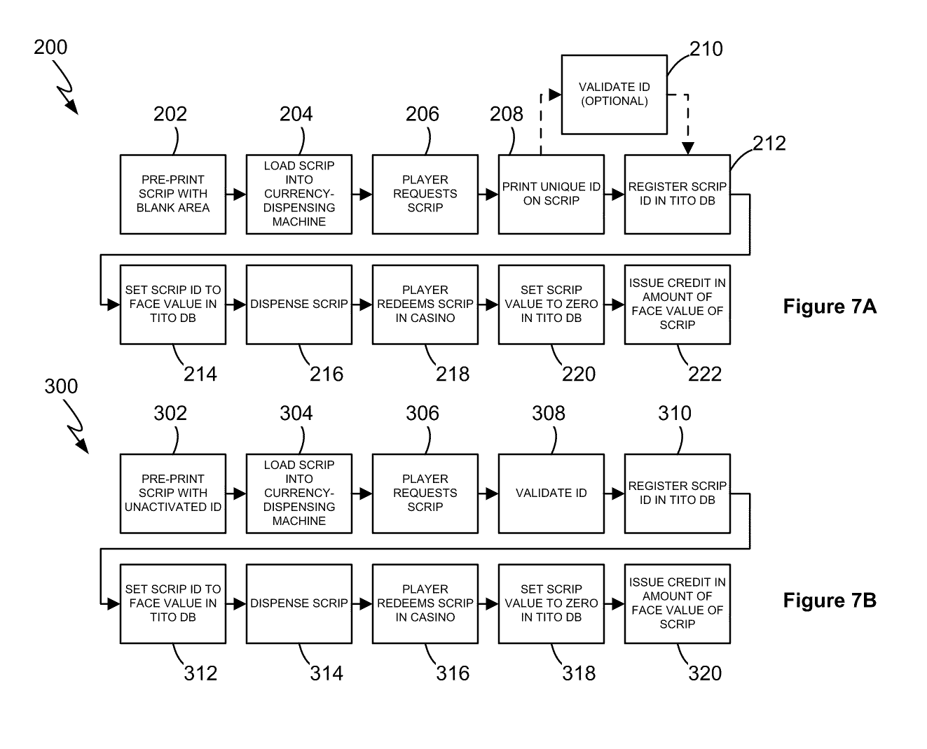

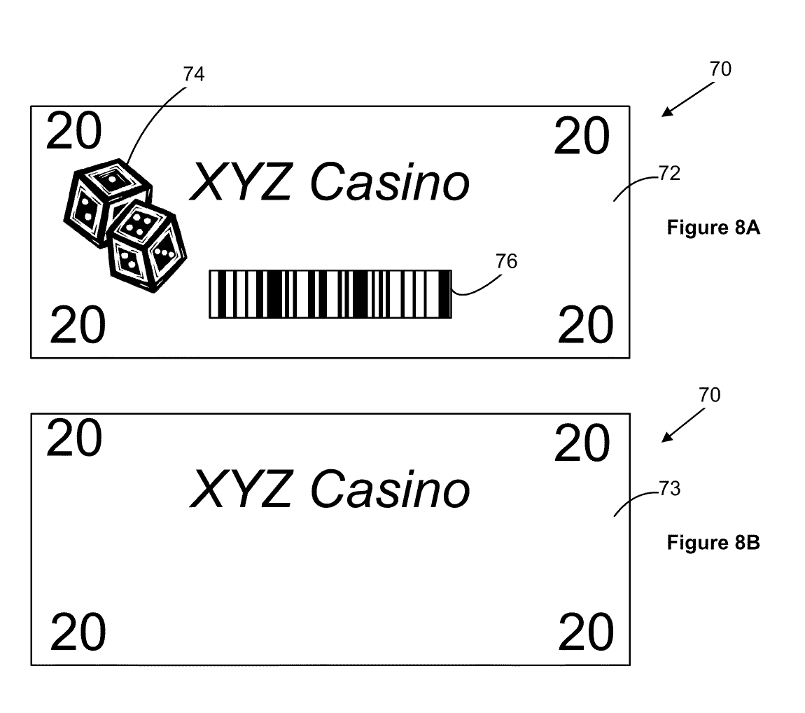

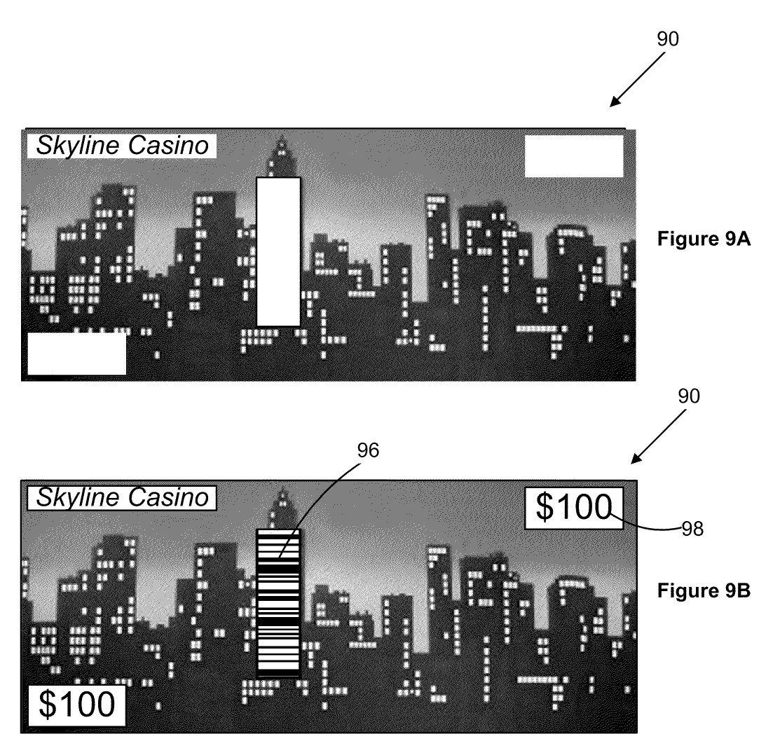

An example of a method 200 of implementing and dispensing scrip in a casino gaming environment is shown in FIG. 7A. In this exemplary method 200, the scrip is first pre-printed, preferably with a face value thereon and with a blank area which will accommodate the unique ID, at step 202. The scrip is then loaded into the currency-dispensing device at step 204. In the event that the face value is not pre-printed onto the scrip, the face value is preferably printed thereon just prior to performing step 204.

After a player requests scrip from the currency-dispensing device at step 206, the unique ID is printed onto the scrip at step 208. Optionally, the ID is validated by the ID validator at step 210. The scrip is then registered in the TITO database at step 212, and the ID on the instrument of scrip is set to the face-value that was pre-printed on the instrument at step 214. The scrip is dispensed to the player at step 216. When the player redeems the scrip in the casino at step 218, for example by inserting it into the bill validator of a gaming machine or an ATM, the value of the scrip is set to zero in the TITO database at step 220, and a credit or cash is issued to the player in the amount of the face value of the scrip at step 222.

The exemplary method 300 shown in FIG. 7B is similar to the method 200 shown in FIG. 7A and described above, except that the scrip is pre-printed with an un-activated, unique ID at step 302 before being loaded into the currency-dispensing device at step 304. Optionally, the face value of the scrip could also be printed thereon during step 302. After a player requests scrip from the currency-dispensing device at step 306, the ID is validated by the bill validator at step 308. The scrip is then registered in the TITO database at step 310. The ID on the scrip is set to the face-value that was pre-printed on the scrip at step 312. The scrip is dispensed to the player at step 314. When the player redeems the scrip in the casino at step 316, the value of the scrip is set to zero in the TITO database at step 318, and a credit or cash is issued to the player in the amount of the face value of the scrip at step 320.

After being “deactivated” in the TITO database (i.e., value set to zero), the scrip may optionally be reused. In the event that the scrip is reused, the process would begin at step 204 or 304 (since the ID would have already been printed onto the scrip) and the face value assigned to the scrip in step 214 or 312 is the same as the face value assigned to the scrip the first time the scrip was activated under step 214 or 312.

As noted above, the system and method for providing scrip described herein could be implemented in a variety of commercial environments, including casinos, retail stores, shopping malls, cruise ships, and the like.

It will be appreciated by those skilled in the art that changes can be made to the embodiments described above without departing from the broad inventive concept thereof. It is understood, therefore, that this invention is not limited to the particular embodiments enclosed, but is intended to cover modifications within the sphere and scope of the present invention.

1. A method comprising:
(a) printing at least one image onto a scrip;
(b) printing a face value onto the scrip;
(c) after performing step (a), providing the scrip to a commercial establishment;
(d) printing a unique identifier on the scrip after step (c) has been performed, the unique identifier being machine readable;
(e) activating the scrip in a database associated with the commercial establishment either simultaneously with or after the performance of step (d), resulting in the scrip being assigned a redemption value within the commercial establishment equal to the face value.

2. The method of claim 1, wherein steps (a) and (b) are performed simultaneously.

3. The method of claim 1, wherein steps (b) and (d) are performed simultaneously.

4. The method of claim 1, wherein step (b) is performed prior to step (d) and after step (c).

5. The method of claim 1, wherein step (e) is performed after step (d).

6. The method of claim 1, wherein step (a) comprises printing at least one image onto the scrip, the at least one image including a blank area that is bordered on at least one side by the at least one image and step (d) comprises printing a unique identifier into the blank area after step (c) has been performed, the unique identifier being machine readable.

7. The method of claim 6, wherein step (a) comprises printing at least one image onto the scrip, the at least one image including a blank area that enveloped by the at least one image.

8. The method of claim 1, wherein step (a) further comprises printing a facing and orientation marking on the scrip.

9. The method of claim 1, further comprising:
(f) loading the scrip into a currency-dispensing device.

10. The method of claim 9, further comprising performing step (f) before performing step (e).

11. The method of claim 9, further comprising:
(g) dispensing the scrip from the currency-dispensing device and performing step (e) as part of step (g).

12. The method of claim 9, further comprising:
(g) dispensing the scrip from the currency-dispensing device and performing steps (d) and (e) as part of step (g).

13. The method of claim 1, wherein step (a) further comprises printing at least one image onto a scrip, the scrip having dimensions that correspond to legal tender in the jurisdiction in which the commercial establishment is located.

14. The method of claim 1, wherein step (b) further comprises printing a face value onto the scrip, the face value being selected from a set of denominations consisting of one or more denominations offered on legal tender in the jurisdiction in which the commercial establishment is located and one or more denominations that are greater than denominations that offered on legal tender in the jurisdiction in which the commercial establishment is located.

15. The method of claim 1, further comprising:
(h) after performing step (e), deactivating the scrip in the database, resulting in the scrip being assigned a redemption value of zero; and
(i) reactivating the scrip in the database after the performance of step (h), resulting in the scrip being assigned a redemption value within the commercial establishment equal to the face value.

16. An apparatus comprising:
a paper ticket including at least one pre-printed image printed on the front side of the paper ticket, at least one pre-printed image having a first blank area located therein, the paper ticket having face value printed thereon and a unique identifier printed in the first blank area after the at least one pre-printed image is printed on the scrip.

17. The paper ticket of claim 16, further comprising a facing and orientation marking printed on a front side of the paper ticket.
